(19) United States
(12) Patent Application Publication
(10) Pub. No.: US 2013/0130717 A1
(43) Pub. Date: May 23, 2013

(54) METHOD AND COMMUNICATION DEVICE FOR DISPLAYING LOCAL TIME

(71) Applicant: SONY MOBILE COMMUNICATIONS AB, Lund (SE)

(72) Inventors: Lisa Winge, Malmo (SE); Hanna Bergsbjörk, Hjarup (SE)

(73) Assignee: SONY MOBILE COMMUNICATIONS AB, Lund (SE)

(21) Appl. No.: 13/632,683

(22) Filed: Oct. 1, 2012

Related U.S. Application Data
(60) Provisional application No. 61/562,467, filed on Nov. 22, 2011.

(51) Int. Cl. H04W 4/02

(52) U.S. Cl. 455/456.3

(57) ABSTRACT

A method and a communication device for displaying local time relating to a person are provided. The communication device determines the local time relating to the person. Next, the communication device displays, at a display device comprised in the communication device, a view relating to the person. The view comprises an indication about the local time.

### CROSS-REFERENCE TO RELATED APPLICATION

This application claims priority under 35 U.S.C. §119, based on U.S. Provisional Patent Application No. 61/562,467, filed Oct. 22, 2011, the disclosure of which is hereby incorporated by reference herein.

### TECHNICAL FIELD

Embodiments herein relates to a communication device and a method therein for displaying local time relating to a person.

### BACKGROUND

In today's modern society, many individuals have friends all over the world. Thanks to social networking services, like Facebook, Gowalla, Foursquare and the like, it is easy to stay in touch and communicate with friends around the world.

In a known scenario, a user of a first cellular phone may intend to contact a friend using a second cellular phone via Facebook. In other known scenarios, the user may utilize Gowalla or Foursquare or even a phone call for contacting the friend.

As an example, a reason for the user to contact the friend may be that the user wishes to discuss the weather with the friend. Since the user and the friend may be located in different parts of the world, a problem may be that the user attempts to contact the friend during the night, which in most cases will be disturbing to the friend.

Moreover, the user may wish to send a birthday greeting to the friend. In this case, another problem may be that the birthday greeting is delivered to the friend at the wrong day due to that the user and the friend are located in different parts of the world and hence also in different time or date zones.

### SUMMARY

Therefore, there is a need for a more user-friendly way of contacting the friend, while it is assured that the friend is contacted at an appropriate time.

According to an aspect, there is provided a method in a communication device for displaying local time relating to a person, such as a friend or the like. The communication device determines the local time relating to the person. Next, the communication device displays, at a display device comprised in the communication device, a view relating to the person. The view comprises an indication about the local time relating to the person.

According to another aspect, there is provided a communication device for displaying local time relating to a person. The communication device comprises a display device and a processing circuit. The processing circuit is configured to determine the local time relating to the person. Furthermore, the processing circuit is configured to display, at the display device, a view relating to the person. The view comprises an indication about the local time relating to the person.

According to another aspect, there is provided a communication device for displaying local time relating to a person. The communication device comprises a display device and a processing circuit. The processing circuit is configured to determine the local time relating to the person. Furthermore, the processing circuit is configured to display, at the display device, a view relating to the person. The view comprises an indication about the local time relating to the person.

Since the indication about local time relating to the person is displayed in the view relating to the person, a user of the communication device is informed about local time relating to the person. Therefore, the user of the communication device is able to determine whether or not to contact the person based on the local time relating to the person, while being provided with the local time in a user-friendly manner. This results in a more user-friendly way of contacting the person. Typically, it is desired to avoid contacting the person when the person is sleeping.

Advantageously, the user of the communication device can conveniently determine whether or not to contact the person based on the local time relating to the person. Therefore, it is herein described an efficient and convenient method for displaying the local time relating to the person to the user of the communication device such that it can be assured that contacting is performed at an appropriate time.

### BRIEF DESCRIPTION OF THE DRAWINGS

The various aspects of embodiments disclosed, herein, including particular features and advantages thereof, will be readily understood from the following detailed description and the accompanying drawings, in which:

FIG. 1 shows a schematic flowchart of exemplifying methods in the

communication device,

FIG. 2 to FIG. 4 show schematic block diagrams of exemplifying views relating to the person, and

FIG. 5 shows a schematic block diagram of exemplifying communication devices configured to perform the methods illustrated in FIG. 1.

### DETAILED DESCRIPTION

Throughout the following description similar reference numerals have been used to denote similar elements, communication devices, parts, items or features, when applicable.

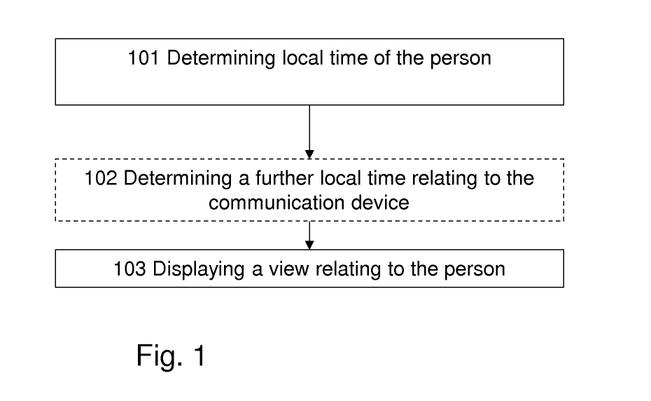

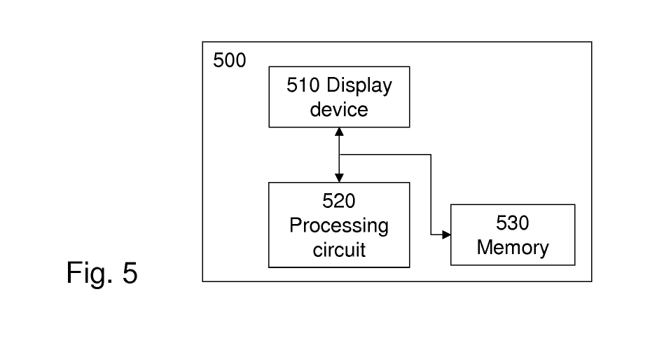

FIG. 1 shows a schematic flowchart of an exemplifying method in a communication device 500 for displaying local time relating to a person. The communication device 500 is illustrated in FIG. 5.

The person may be a friend, colleague, acquaintance, family member or the like to a user of the communication device 500. In this example, the communication device 500 is a cellular phone. In other examples, the communication device may be a user equipment, a mobile phone, a Personal Digital Assistant (PDA) equipped with radio communication capabilities, a tablet Person Computer (tablet PC), a smartphone or the like.

The method comprises the following actions, which may be performed in any suitable order. For example, action 101 may be performed after action 102.

### Action 101

The communication device 500 determines the local time relating to the person. The local time will be used in action 103 below. This action may be performed when, or just before, the user of the communication device 500 attempts to contact the person.

As an example, the local time is determined by the communication device 500 based on contact information about the person. Typically, the contact information is comprised in a memory of the communication device 500. The memory, denoted 530, is shown in FIG. 5. The contact information may be obtained from an address book within the communication device 500.

As another example, the local time is determined by the communication device 500 based on a message comprising geographical and/or time zone information. The message has been received from the person. The message may comprise a so called geo-tag. Geo-tags are known in the art. The message may be a Short Messaging Service (SMS) message, a Multi Media Service (MMS) message or the like.

As a further example, the local time is determined by the communication device 500 based on a location of the person. The location is obtained from a service, such as Gowalla, Foursquare or Facebook, for providing the location of the person. The location of the person is indicating where the person is located.

In still further examples, the local time is based on a combination of two or more of the above mentioned examples of determining the local time.

### Action 102

In some embodiments, the communication device 500 may determine a further local time relating to the communication device 500. Expressed differently, local time relating to the user of the communication device 500 is determined. When the further local time relating to the communication device 500 is different from the local time relating to the person, the local time may be displayed at the display device as described in action 103.

As an example, the local time relating to the person is a first local time and the local time relating to the user of the communication device 500 is a second local time. Thus, when the first local time is different from the second local time, the first local time is displayed at the display device as in action 103.

### Action 103

At a display device comprised in the communication device 500, the communication device 500 displays a view relating to the person. The view comprises an indication about the local time. As a result, a user of the first communication device 500 is provided with information about local time relating to the second user, which is about to be contacted/communicated with, in a user-friendly manner. As a consequence thereof, the user of the first communication device 500 is able to determine whether or not it is appropriate to pursue the intended communication with the person.

The indication may be any kind of user interface object suitable for displaying the local time at the display device. Typically, the indication may be a user interface object for displaying characters, indicating the local time. In this example, it may be a digital clock, watch or the like. In other examples, the indication may be a user interface object for graphically representing the local time. As an example, a graphical representation of the local time may be in the form of an illustration of an analogue clock, watch or the like.

As a first example, the view relating to the person may be a contact view displayed by a first application for managing contact information. The first application is executed on the first communication device 500 and the contact view displays detailed contact information relating to the person or a list of contact information relating to a plurality of persons.

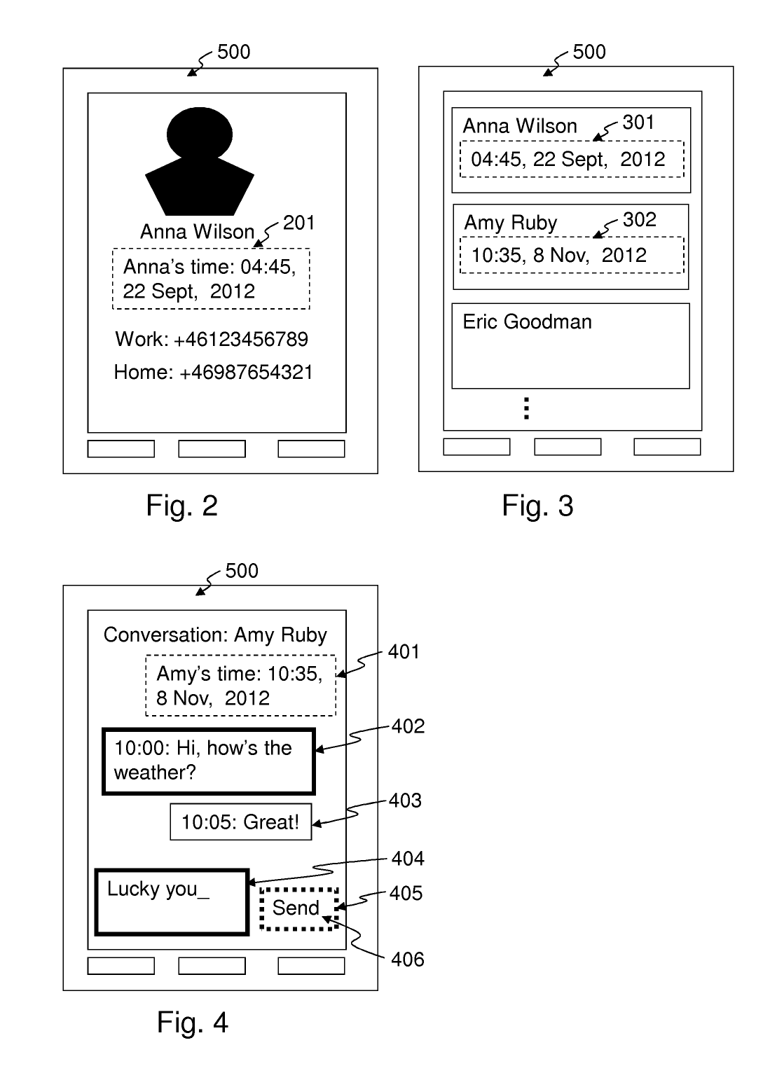

In the example of FIG. 2, the contact view is a detailed view for displaying detailed contact information relating to the person. The dashed square 201 may be an indication of the local time. In this example, the displaying of the view relating to the person, i.e. the contact view, may be performed in response to selection of the person. The selection may be performed by the user in any suitable manner, such as by tapping, clicking, pressing or the like.

In the example of FIG. 3, the contact view is a list view for displaying a list of contact information relating to a plurality of persons. In this example, only three persons are shown, but as indicated by a group comprising three dots in a lower portion of the Figure, there may in other examples be an arbitrary number of persons. In this example, an upper and a lower dashed square 301, 302 indicate local time for Anna Wilson and Amy Ruby, respectively. In this example, the displaying of the contact view may be performed in response to a selection of an application for managing the list of contacting information. The selection may be performed by the user in any suitable manner, such as by tapping, clicking, pressing or the like. The application may be an address book application or the like.

As a second example, the view relating to the person may be a communication view displayed by a second application for managing messages. The second application is executed on the first communication device 500. In this example, the displaying of the communication view may be performed in response to a selection of an application for communication, via SMS, MMS or the like, with the person. The selection may be performed by the user in any suitable manner, such as by tapping, clicking, pressing or the like. The application may be a messaging application for sending SMS messages, MMS messages or the like.

In the example of FIG. 4, the communication view displays a message thread relating to the person. The message thread may comprise a conversation between the person and the user of the communication device 500. In this example, the person is Amy Ruby. In this example, the indication is represented by a farther dashed square 401, which depicts any user interface object suitable for displaying the local time for Amy Ruby. An upper and a lower thick-lined square 402, 404 relate to statements from the user of the communication device 500. A thin-lined square 403 relates to Amy Ruby's reply to a question about the weather. A thick-lined dotted square 405 denotes a button 406 which may be activated by the user of the communication device 500 to send the text “Lucky you” held by the lower thick-lined square 404. The user may activate the button by pressing, taping or clicking at the button. The button is a user interface object for activation by the user in any of the above mentioned manners.

In other examples, the communication view displays a message relating to the person. The message may be a message received from the person or the message may be a message to be sent to the person. In both cases, it is useful to obtain an indication about the local time relating to the person in a user-friendly manner. Again, the message may be an SMS message, an MMS message or the like.

As mentioned above, the displaying of the local time in the view may be conditional upon that the further local time is different from the local time. The further local time was determined in action 102 and the local time was determined in action 101.

FIG. 5 shows a schematic block diagram of the exemplifying communication device 500, which is configured to perform the method illustrated in FIG. 1. The communication device 500 is configured to display the local time relating to the person. The communication device 500 may be a cellular phone, a user equipment, a mobile phone, a Personal Digital Assistant (PDA) equipped with radio communication capabilities, a tablet Personal Computer (tablet PC), a smartphone or the like.

The communication device 500 comprises a display device 510. The display device 510 may be any kind of display for mounting the communication device 500. In some examples, the display device 510 has functionality for receiving tactile input from the user. In those examples, the display device 510 is a touch screen. In other examples, the input from the user is received via an input device for manipulating user interface objects. The input device may be a mouse, a keyboard, a keypad or the like.

The communication device 500 comprises a processing circuit 520 configured to determine the local time relating to the person. The processing circuit 520 is further configured to display, at the display device 520, a view relating to the person. The view comprises an indication about the local time.

The processing circuit 520 may farther be configured to determine the local time based on one or more of: contact information about the person, which contact information is comprised in a memory 530 of the first communication device 500, a message comprising geographical and/or time zone information, the message being received from the person; or location of the person, wherein the location is obtained from a service for providing the location of the person. The message may be an SMS message, an MMS message or the like.

The view relating to the person may comprise a contact view displayed by a first application for managing contact information. The first application is executed on the first communication device 500. The contact view displays detailed contact information relating to the person or a list of contact information relating to a plurality of persons.

Alternatively, the view relating to the person may comprise a communication view displayed by a second application for managing messages. The second application may be executed on the first communication device 500. The communication view displays a message thread relating to the person or a message relating to the person.

The processing circuit 520 may further be configured to determine a further local time relating to the communication device 500. The further local time relating to the communication device 500 may be different from the local time relating to the person.

The processing circuit 520 may be a processing unit, a processor, an application specific integrated, circuit (ASIC), a field-programmable gate array (FFGA) or the like. As an example, a processor, an ASIC, an FPGA or the like may comprise one or more processor kernels.

The communication device 500 further comprises a memory 530 for storing software to be executed by, for example, the processing circuit. The software may comprise instructions to enable the processing circuit to perform the method in the communication device 500 as described above in conjunction with FIG. 1. The memory 530 may be a hard disk, a magnetic storage medium, a portable computer diskette or disc, flash memory, random access memory (RAM), a portion of a subscriber identity module or the like. Furthermore, the memory may be an internal register memory of a processor.

Even though embodiments of the various aspects have been described, many-different alterations, modifications and the like thereof will become apparent for those skilled in the art. The described embodiments are therefore not intended to limit the scope of the present disclosure.

1. A method in a communication device for displaying a local time relating to a person, wherein the method comprises:
determining the local time relating to the person;
displaying, at a display device comprised in the communication device, a view relating to the person, wherein the view comprises an indication about the local time.

2. The method according to claim 1, wherein the determining of the local time relating to the person is based on one or more of:
contact information about the person, the contact information being comprised in a memory of the first communication device;
a message comprising geographical and/or time zone information,
wherein the message is received from the person;
location of the person, wherein the location is obtained from a service for providing the location of the person.

3. The method according to claim 1, wherein the view relating to the person comprises one of:
a contact view displayed by a first application for managing contact information,
wherein the first application is executed on the first communication device and the contact view displays detailed contact information relating to the person or a list of contact information relating to a plurality of persons; and
a communication view displayed by a second application for managing messages, wherein the second application is executed on the first communication device and the communication view displays a message thread relating to the person or a message relating to the person.

4. The method according to claim 1, further comprising;
determining a further local time relating to the communication device, wherein the farther local time relating to the communication device is different from the local time relating to the person.

5. The method according to claim 1, wherein the communication device comprises a mobile phone.

6. The method according to claim 2, wherein, when the determining of the local time relating to the person is based on at least the message, the message comprises a Short Messaging Service message or a Multi Media Service message.

7. A communication device for displaying local time relating to a person, comprising:
a display device; and
a processing circuit configured to:
determine the local time relating to the person; and
display, at the display device, a view relating to the person, wherein the view comprises an indication about the local time.

8. The communication device according to claim 7, wherein the processing circuit is further configured to determine the local time based on one or more of:
contact information about the person, the contact information being comprised in a memory of the first communication device;
a message comprising geographical and/or time zone information, wherein the message is received from the person; or
a location of the person, wherein the location is obtained from a service for providing the location of the person.

9. The communication device according to claim 7, wherein the view relating the person comprises one of:
a contact view displayed by a first application for managing contact information,
wherein the first application is executed on the first communication device and the contact view displays detailed contact information relating to the person or a list of contact information relating to a plurality of persons; and
a communication view displayed by a second application for managing messages,
wherein the second application is executed on the first communication device and the communication view displays a message thread relating to the person or a message relating to the person.

10. The communication device of claim 7, wherein the processing circuit further is configured to determine a further local time relating to the communication device, and
wherein the further local time relating to the communication device is different from the local time relating to the person.

11. The communication device according to claim 7, wherein the communication device comprises a mobile phone.

12. The communication device according to claim 8, wherein, when the processing circuit is configured to determine the local time relating to the person is based on at least the message, the message comprises a Short Messaging Service message or a Multi Media Service message.
